(19) United States
(12) Patent Application Publication
(10) Pub. No.: US 2004/0023199 A1
(43) Pub. Date: Feb. 5, 2004

(54) Technology explorer toy

(76) Inventor: Robert William Lally, Orchard Park, NY (US)

Correspondence Address: Robert W. Larry, 7 Eagle Heights Drive, Orchard Park, NY, 14127, US

(21) Appl. No.: 10/631,247

(22) Filed: Jul. 31, 2003

Related U.S. Application Data
(63) Continuation-in-part of application No. 09/031,611, filed on Feb. 27, 1998, now Pat. No. 6,443,736.

(51) Int. Cl. G09B 23/06

(52) U.S. Cl. 434/300

(57) ABSTRACT

Involving mysterious gravity and mystical energy, an adjustable, educational, structural model incorporates an object suspended from a frame in various ways with flexible line, and instrumented with masses connected to it by springs. The structure functions to transfer forces of nature and man into motion, and motion into deflection of the springs, that both sense and suppress motion. Changing the structure modifies its behavior in unusual ways. Sensors don't sense, objects don't bounce, and motion doesn't change, as expected. Adding weights to a swinging object, which falls freely along its arcing path, does not change the coasting rate, thus verifying Newton's famous laws of motion. Testing the behavior and monitoring the health of the structural model dramatically demonstrates the radiant, vibrant, communicant, dynamic nature and behavior of energetically interacting people and things, and how forces involved in transfers of energy animate the world.

### CROSS-REFERENCE TO RELATED APPLICATION

This application is a continuation in part of application Ser. No. 09/031,611 filed Feb. 27, 1998, and issued as U.S. Pat. No. 6,443,736 B1 on Sep. 3, 2002.

### BACKGROUND OF THE INVENTION

The present invention generally relates to the fields of toys, physics, education and demonstration, and measuring and testing.

As always, wants and needs exist today for a practical way to introduce technology, a fun way to technically self-educate and train people, and a creative way to entertain children and executives. Being earth-bound energy engines, hu-man the machine, many people, including children, teachers and workers, have a want or need to know more about technology, especially about mysterious gravity and mystical energy. Children enjoy animating their world.

Although abundant, precious energy evidently exists, it cannot be sensed or measured directly, and can be experienced only during transition as an effort moving something. Ironically, sensors, like humans, employ structures and the natural way structures energetically interact to sense and communicate information. No wonder sensors are often viewed as mystical devices.

Applying modem technology to an old device, a children's swing, the present invention, an educational toy, involves testing and pleasantly experiencing the radiant, vibrant, resonant, communicant nature and behavior of energetically interacting people and things. Through the antics of visual motion sensors resembling lollipops, this interactive toy demonstrates how forces of nature and man involved in the transfer of energy animate the world. Visual motion sensors dramatically show what happens to the force and motion involved in energy transfers when there is little, none, or excessive energetic interaction.

Testing the behavior of a freely swinging body also verifies Newton's famous laws of motion. Adding mass does not change the coasting rate of a swing, which acts as a freely falling body along its guided, arcing path. It behaves similar to the way vertically falling bodies all initially accelerate at the same rate under the influence of gravity, regardless of weight. Local gravity is a known, nearly constant force experienced as weight.

Experiments testing the behavior and monitoring the health of familiar structures, similar to the way doctors test reflexes, both entertain and enlighten. Changing a structure to modify its behavior often results in unusual events that both puzzle and fascinate people.

### BRIEF SUMMARY OF THE INVENTION

Accordingly, many of the above wants and needs are met by the present invention of an adjustable, instrumented, structural model incorporating a freely moving object suspended on flexible lines either as a swing or bungee-jumping rig. When manually energized, this structural model functions to transfer forces of nature and man into motion, and motion into deflection of springs. Changing the structure modifies its behavior in unusual ways.

Compressible materials and connections ease the task of assembling the structure, adjusting alignment, installing the sensors, and changing the configuration. Sensors and weights made of hard rubber material simply and conveniently plug onto oversize plastic posts protruding from the test object, and are elastically clamped in place. To adjust the length of the suspension and the alignment of the test object, a one-piece, flexible, plastic-coated suspension line slides in holes in the test object and frame that lightly grip it. Knots hidden in holes terminate and secure the two ends of the line. Novel design features facilitate changing the structure to modify its behavior.

Classical, mass-loaded, spring structures resembling lollipops serve as visual motion sensors. Naturally interacting with the moving test-object body and the earth, they both sense and suppress motion in the direction their flat, leaf spring deflects. The sensor assembly on top of the swinging object simulates a person, and experiences the soothing, relaxed feeling a person enjoys when rhythmic coasting in a simple swing.

But, as demonstrated, without a transfer of energy nothing is sensed, too much energy transfer changes the motion of interest, and sensors can't tell the difference between acceleration and gravity. Popular motion-sensing accelerometers employ similar structures.

Like a toy chemistry set or electronics kit, various physical experiments entertain and enlighten. Surprisingly, the sensors normally deflect to sense the horizontal coasting motion of a glider type swing, but not that of a simple swing. Adding or removing mass does not change the swinging rate. Shortening the suspension speeds up the motion. Manually moving the pivots back and forth at the natural swinging rate builds up big excursions. With an alternate elastic suspension connected, the swing both coasts and bounces. An elastically suspended, freely falling body instrumented with an array of tuned, vertically flexing sensors does not bounce or oscillate as expected. Vertically flexing sensors deflect downward, indicating motion even when there is none.

Therefore, the primary object of this invention is an entertaining, educational toy that demonstrates how forces of nature and man involved in energy transfers animate the world by causing things to move and events to happen.

Another object of this invention is to demonstrate behavior testing and health monitoring of things by manually disturbing an object and observing or sensing its motion, similar to the way a doctor test reflexes.

Another object of this invention is to demonstrate how energetically interacting structures sense and communicate information.

Still another object of this invention is to help children incidentally experience and enjoy the radiant, vibrant, communicant nature and behavior of energetically interacting people and things.

### BRIEF DESCRIPTION OF SEVERAL VIEWS OF THE DRAWINGS

The structure of the preferred embodiment of the instrumented educational toy is illustrated in following drawings, in which:

FIG. 1 is a partially sectioned, side elevation view of the invention showing an object suspended from a wire frame as both a simple and glider type swing instrumented with visual motion sensors.

FIG. 2 is a partially sectioned, front elevation view of the same structural model showing an alternate, elastic suspension line, which is not connected to the test object.

### DETAILED DESCRIPTION OF THE INVENTION

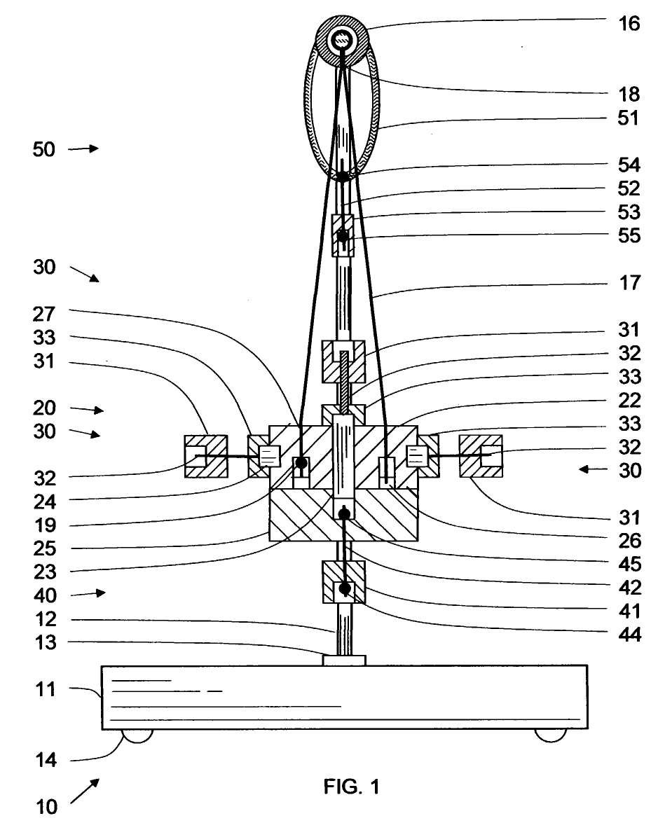

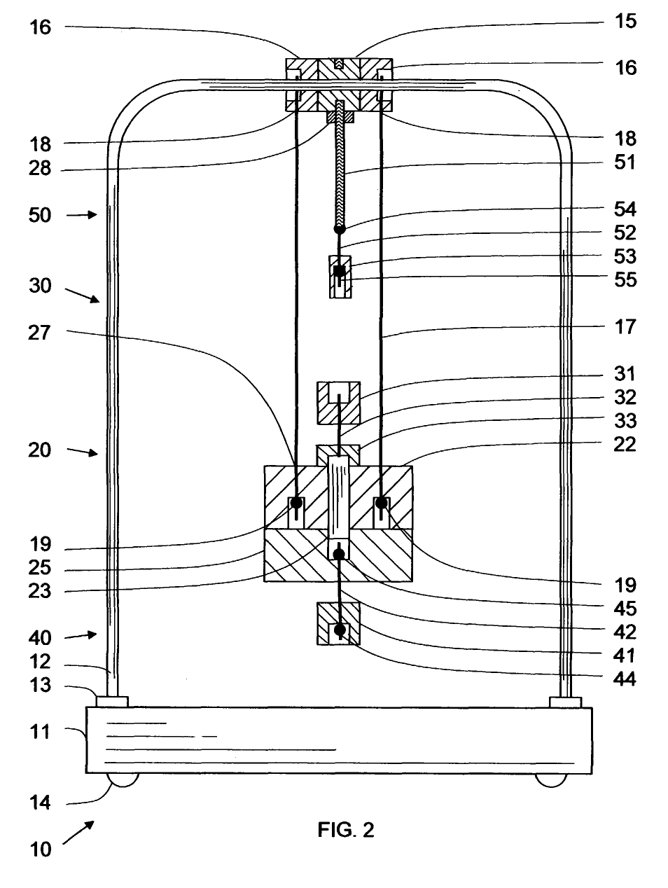

FIG. 1 and FIG. 2, which are different views of the same object, illustrate an instrumented, adjustable, structural model incorporating a cylindrical, test-object body 22 suspended on a flexible line 17 as a swing from two pivot bushings 16 spaced apart on support rod 12. Holes in the test object body 22 and pivot bushings 16 route and grip the suspension line 17 at multiple pivot points 18 and 27.

The test-object body 22 coasts back and forth in the plane of the support rod 12 as a glider type swing with parallel suspension arms 17 when energized in the direction of an imaginary line between the two pivots. Perpendicular to the plane of the support rod 12, the body 22 coasts as a simple swing with one composite suspension arm when energized in a direction perpendicular to the imaginary line between the pivots.

The frame supporting the suspended test-object body 22 consists a formed, metal, inverted U-shaped, support rod 12 connected to a wood base block 11, and pivot bushings 15 and 16 made of hard rubber material gripping the support rod 12 The metal rod 12 plugs into hard rubber inserts 13 in the base block 11, which impart additional flexibility. Soft plastic feet 14 located underneath each corner of the base block 11 help level and isolate the model when placed on uneven surfaces. Manually moving the top of the metal support rod 12 and pivot bushings 16 back and forth slowly energizes the swing.

The flexible, one piece, suspension line 17 clamps to the frame and test object body 22 at multiple pivot points 18 and 27, forming two triangular-shaped loops spaced apart that suspend the body 22 on four like sections of line 17. The line 17 threads through holes 18 in the two pivot bushings 16, loops around the support rod 12, routes back out through the holes 18, then goes down through the four holes 27 located at corners of a square in the body 22, where knots 19 secure the ends of the line 17. In a groove 26 in the bottom surface the body 22, the line 17 crosses from the triangular loop on one side of the body 22 to the loop on the other side. Routing and lightly gripping the smooth, plastic-coated line 17, holes in the body 22 and bushings 16 allow it to slip through to level and align the test-object body 22 relative to the frame.

Pulling the knotted ends of the line 17 out of the holes in the body 22 and tying temporary knots shortens the suspension and speeds up the swinging action.

In the direction of arrow 50, an alternate, vertical suspension line is composed of an elastic upper section 51 connected to a flexible lower section 52. The flexible line 52 ties to a loop of bungee cord 51 draped around a groove in bushing 15. The other end of line 52 connects to a rigid plastic post 53 that inserts into a hole in hard-rubber mass 31, which grips it. Knots 54 and 55 tied near the ends line 52 secure the assembly. A hard-rubber disk 28 with a central hole clamps the two sides of the bungee cord 51 together to form a pivot underneath the bushing 15. This alternate, elastic suspension allows the test-object body 22 to swing and bounce freely in any direction, and to briefly fall freely for a period of time after being lifted and dropped, or pulled down and released.

Three motion sensors connect to the top and sides of test-object body 22. They are structured with a seismic mass 31 made of hard rubber, and connected and clamped to one end of a flexible, flat, plastic-beam type spring 32. The other end of the beam spring 32 connects and clamps to a mounting-adapter block 33, also made of hard rubber. It connects to a tubular post 23 or 24 protruding from the test-object body 22. The beam 32 of the top-mounted sensor flexes horizontally. The beams 32 of the two, diametrically-opposed, side-mounted sensor assemblies flex vertically, and are tuned to resonate at about the same natural frequency as the elastically suspended body 22. This array of sensors sense and suppress vertical bouncing motion when the test object mass is lifted and dropped. Rotating the sensor mounting adapter 33 on the mating post changes the direction the beam 32 flexes and senses. The elastic, beam 32 type spring deflects when the test-object mass 22 accelerates in the direction the spring flexes or deflects.

The motion-sensor mounting adapter 33 made of a block of hard rubber material has a cylindrical hole smaller than a mating post 24 protruding from the test object 22 that it plugs onto and grips When installed, residual stresses in the adapter 33 clamp together in intimate contact mating mounting surfaces having a similar contour.

A fourth motion sensor structured with a seismic mass 41 hangs on one end of another flexible line 42. The other end of the line 42 connects and clamps by means of an auxiliary, hard-rubber weight 25 to tubular post 23 extending from the bottom of test-object body 22. The line 42 threads through holes in the seismic mass 44 and auxiliary mass 25. Knots 44 and 45 tied near the ends of the line 42 secure the assembly. Gravity acting as a spring tends to restore the sensor to its neutral vertical position. This subassembly can be attached or removed to change the mass and weight of the swinging test-object 22.

Operation involves manually disturbing or energizing the structure in some way, and observing the resultant motion of the suspended test-object body 22, similar to the way a doctor tests reflexes. Many of the following seven basic experiments involve changing the structure to modify its behavior:

1. Manually disturbing the swinging object allows it to coast back and forth at a natural rate, less than once per second, under the influence of gravity. Falling freely along its arcing path of motion, the mass of the swinging object interacting with the earth alternately stores the manually imparted energy as position and speed, until friction in the lines and air gradually dissipates and stores it as heat. Similar to the way a person energizes a regular swing, manually moving the flexible frame and pivots of the swing back and forth at the natural coasting rate of the swing adds energy in small amounts to gradually build up big swinging excursions of the test object.

2. Adding weights to the swinging test object doesn't change its coasting motion, thus verifying Newton's famous law of motion, F=ma, which is the only logical explanation. The effect of the increase in mass (inertia) is cancelled by the related proportional increase in force (weight).

3. Changing the direction of the swing motion affects the behavior of the sensors. Sensor springs deflect to sense the horizontal coasting motion of the glider swing, but not that of the simple swing. In the glider swing, gravity always acting vertically downward can't directly help move the sensor mass back and forth horizontally. In the simple swing, tension in the suspension lines always acting perpendicular to the path of the simple swing can't help move the sensor mass along its arcing path. Gravity moves the entire assembly.

4. Shortening the length of the suspension lines speeds up the coasting rate of the swinging object, because, of the change in the geometry. A bigger part of gravity propels it.

5. Lifting and dropping an elastically suspended object with an array of tuned, vertically flexing sensors attached to sense and virtually suppress the bouncing motion.

6. Quietly suspending an instrumented test object, and seeing the horizontal beam of a vertical motion sensor droop downward, indicating motion when there is none. In this situation, the deflection of the beam represents one local g of acceleration.

7. Swinging an elastically suspended test object, and seeing it simultaneously coast and bounce after being energized, because tension in the suspension line due to gravity changes along its arcing path. The elastic bungee-cord loop acts as a force sensor measuring tension. The swing assembly acts like a classical spring-mass motion sensor responding to a changing part of gravity.

Therefore, the creative concepts in the present invention provide a practical, useful, low cost, instrumented, educational structural-model toy incorporating and demonstrating state-of-the-art technology. In a fun way, it helps introduce, explore, demonstrate, and self-teach important technical concepts, such as energetic interaction, sensing and communicating, and structural behavior testing. With an electronic sensor kit, it can also serve as a valuable, high-technology, interactive, desktop teaching and training accessory for expanded computers acting as virtual oscilloscopes or spectrum analyzers. When constructed with sports items, such as hockey pucks, lacrosse balls and fishing line, it visibly as well as mentally links sports and technology.

I claim:

1. An educational toy for exploring technology, comprising:
a frame;
an object suspended from said frame;
a flexible line connecting said object to said frame;
at least one sensor having a mass attached to a spring connected to said object;
whereby said object under the influence of gravity moves freely after being manually energized, and said spring deflects when said object accelerates normally in the direction said spring deflects.

2. The educational toy of claim 1, wherein said object is a cylindrical body of hard rubber material having holes routing and gripping said line.

3. The educational toy of claim 1, wherein said line is one piece clamped to said object and said frame at multiple pivot points forming two triangular-shaped loops spaced apart that suspend said object on four like sections of said line;
whereby said line slides relative to said frame and said object to adjust and align the position of said object.

4. The educational toy of claim 1, wherein said line is connected to said frame at two pivots spaced apart,
whereby said object coasts as a glider type swing with parallel suspension arms when manually energized in the direction of a line between said pivots,
and coasts as a simple swing with one composite suspension arm when energized in a direction perpendicular to said line.

5. The educational toy of claim 1, wherein said suspension line is comprised of an elastic upper section connected to a flexible lower section,
whereby said object falls freely for a period of time after being lifted and dropped,
or pulled down and released,
and said object both swings and bounces freely when energized horizontally.

6. The educational toy of claim 1, wherein an array of said sensors mounted on said object both sense and suppress the motion of said object.

7. The educational toy of claim 1 wherein said spring is a flat plastic beam,
having one end connected to said mass,
and the other end connected to a mounting-adapter block made of hard rubber material that connects to said object.

8. The educational toy of claim 1 wherein said sensor is comprised of said mass connected to one the end of another flexible line,
and the other end connected to the bottom of said object;
whereby gravity acting as a spring tends to restore said sensor to its neutral, vertical position.

9. The educational toy of claim 1 wherein
said frame is a formed metal rod connected to a wood base block,
whereby manually moving the top of said rod back and forth gradually builds up big swinging excursions of said object.

10. A motion-sensor mounting adapter composed of a block of hard-rubber material connected to said motion sensor,
having a cylindrical hole smaller than a mating post protruding from the test object,
and having a mounting surface contour similar to that of said test object,
whereby when installed, said block grips said post, and residual stresses clamp said mounting surfaces together in intimate contact.
